(19) United States
(12) Patent Application Publication
(10) Pub. No.: US 2008/0200605 A1
(43) Pub. Date: Aug. 21, 2008

(54) Method For Producing An Aqueous Polymer Dispersion

(75) Inventors: Jacob Wildeson, Charlotte, NC (US); Thomas Danner, Erpolzheim (DE); Sonja Viereck, Mannheim (DE); Andreas Bauder, Mannheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF AKTIENGESELLSCHAFT, LUDWIGSHAFEN (DE)

(21) Appl. No.: 11/916,758

(22) PCT Filed: Jun. 20, 2006
(86) PCT No.: PCT/EP2006/063354

§ 371 Date: Dec. 6, 2007

(30) Foreign Application Priority Data
Jun. 21, 2005 (DE) 102005028989.4

(51) Int. Cl. C08L 25/10; C08L 33/06

(52) U.S. Cl. 524/560; 524/575; 524/563

(57) ABSTRACT

The process for preparing an aqueous polymer dispersion using microporous membranes.

The present invention provides a process for preparing an aqueous polymer dispersion, which comprises
a) first preparing an organic polymer solution formed from a low water solubility polymer and a low water solubility organic solvent, then
b) introducing the resulting organic polymer solution into an aqueous medium which comprises dispersion assistant, then
c) converting the resulting heterogeneous mixture by means of suitable measures to an oil-in-water emulsion with a mean droplet diameter of ≧2 μm (crude emulsion), then
d) passing the resulting crude emulsion through a microporous membrane to form an oil-in-water emulsion with a mean droplet diameter ≦1000 nm (miniemulsion), and then
e) removing the organic solvent from the miniemulsion.

Aqueous polymer dispersions are frequently prepared by the method of free-radically initiated aqueous emulsion polymerization. This method has been described many times before and is therefore sufficiently well known to those skilled in the art [cf., for example, Encyclopedia of Polymer Science and Engineering, Vol. 8, pages 659 to 677, John Wiley & Sons, Inc., 1987; D. C. Blackley, Emulsion Polymerisation, pages 155 to 465, Applied Science Publishers, Ltd., Essex, 1975; D. C. Blackley, Polymer Latices, 2^{nd} Edition, Vol. 1, pages 33 to 415, Chapman & Hall, 1997; H. Warson, The Applications of Synthetic Resin Emulsions, pages 49 to 244, Ernest Benn, Ltd., London, 1972; D. Diederich, Chemie in unserer Zeit 1990, 24, pages 135 to 142, Verlag Chemie, Weinheim; J. Piirma, Emulsion Polymerisation, pages 1 to 287, Academic Press, 1982; F. Holscher, Dispersionen synthetischer Hochpolymerer, pages 1 to 160, Springer-Verlag, Berlin, 1969 and the patent DE-A 40 03 422]. The free-radically initiated aqueous emulsion polymerization is effected typically in such a way that the ethylenically unsaturated monomers, generally with additional use of dispersing assistants, are dispersed in aqueous medium and polymerized by means of at least one free-radical polymerization initiator. Frequently, the residual contents of unconverted monomers in the resulting aqueous polymer dispersions are lowered by chemical and/or physical methods which are likewise known to those skilled in the art [see, for example, EP-A 771328, DE-A 19624299, DE-A 19621027, DE-A 19741184, DE-A 19741187, DE-A 19805122, DE-A 19828183, DE-A 19839199, DE-A 19840586 and 19847115], the polymer solids content is adjusted to a desired value by dilution or concentration, or further customary additives, for example bactericidal or foam-suppressing additives, are added to the aqueous polymer dispersion. A disadvantage of the method of aqueous emulsion polymerization is that aqueous polymer dispersions can be obtained only starting from ethylenically unsaturated monomers.

Additionally known is the preparation of aqueous polymer dispersions in the form of so-called secondary aqueous polymer dispersions (on this subject, see, for example, Eckersley et al., Am. Chem. Soc., Div. Polymer Chemistry, 1977, 38(2), pages 630, 631, U.S. Pat. No. 3,360,599, U.S. Pat. No. 3,238,173, U.S. Pat. No. 3,726,824, U.S. Pat. No. 3,734,686 or US-A 6,207,756). The secondary aqueous polymer dispersions are prepared generally in such a way that the polymers are dissolved in an organic solvent and dispersed in an aqueous medium to form aqueous polymer/solvent (mini)emulsions. Subsequent solvent removal affords the corresponding aqueous polymer dispersions. A disadvantage of the aforementioned secondary aqueous polymer dispersions is their broad particle size distribution and the required relatively large amounts of dispersing assistant in order to keep the polymer particles in dispersed form. Further advantages are the high energy inputs required for the preparation, combined with high shear forces, and also the resulting high coagulate contents of the resulting secondary aqueous polymer dispersions.

It was an object of the present invention to provide a process for preparing secondary aqueous polymer dispersions which does not have the aforementioned disadvantages.

Surprisingly, the object has been achieved by the process defined at the outset.

It is essential to the invention that the polymer used and the organic solvent used have a low solubility in water. In the context of this document, it shall be understood to mean a solubility of the polymer or the organic solvent in deionized water at 20° C. and 1 atm (absolute) of ≦50 g/l, preferably ≦10 g/l and advantageously ≦5 g/l or ≦1 g/l.

According to the invention, it is possible to use all polymers which have a low water solubility and which are capable of forming a homogeneous polymer solution with a low water solubility organic solvent. In particular, it is possible in the process according to the invention to use the following polymers: polyolefins based on linear or branched C₂ to C₂₀ aliphatic or aromatic mono- or diethylenically unsaturated compounds, for example the homo- or copolymers based on ethene, propene, 1-butene, 2-butene, 2-methylpropene (isobutene), 1,3-butadiene, isoprene, styrene, in particular the homopolymers polyethene, polypropene, poly-1-butene, polyisobutene, polybutadiene or polystyrene, or the corresponding copolymers composed of ethene/propene, ethenel-butene, ethene/isobutene, propene/1-butene or propene/isobutene, polyesters based on C₃ to C₁₅ aliphatic lactone compounds and also linear or branched C₂ to C₂₀ aliphatic or aromatic diol compounds and linear or branched C₂ to C₂₀ aliphatic or aromatic dicarboxylic acid compounds, for example polyesters based on terephthalic acid/ethylene glycol or hexadecamethylenedicarboxylic acid/propylene glycol, polyamides based on C₃ to C₁₅ aliphatic lactam compounds and also linear or branched C₂ to C₂₀ aliphatic or aromatic primary diamine compounds and linear or branched C₂ to C₂₀ aliphatic or aromatic dicarboxylic acid compounds, for example polyamides based on ε-caprolactam or hexamethylenediamine/adipic acid, polyurethanes based on linear or branched C₂ to C₂₀ aliphatic or aromatic diol compounds and linear or branched C₂ to C₂₀ aliphatic or aromatic diisocyanate compounds, for example polyurethanes based on 1,6-hexanediol and also polyether- and/or polyesterdiols and tolylene 2,4- or 2,6-diisocyanate, hexamethylene diisocyanate or methylene 4,4′-di(phenylisocyanate), polycarbonates based on linear or branched C₂ to C₂₀ aliphatic or aromatic diol compounds and phosgene or based on epoxides and carbon dioxide, for example polycarbonates based on ethylene glycol/phosgene, ethylene oxide/carbon dioxide or propylene glycol/carbon dioxide and/or polymers which have been obtained by free-radical polymerization of a monomer mixture comprising
from 50 to 99.9% by weight of esters of acrylic and/or methacrylic acid with alkanols having from 1 to 20 carbon atoms, in particular esters of acrylic acid and/or methacrylic acid with methanol, ethanol, propanol, isopropanol, n-butanol or 2-ethylhexanol, or
from 50 to 99.9% by weight of styrene and/or butadiene, or
from 50 to 99.9% by weight of vinyl chloride and/or vinylidene chloride, or
from 40 to 99.9% by weight of vinyl acetate, vinyl propionate, vinyl esters of versatic acid, vinyl esters of long-chain fatty acids and/or ethylene.

In the context of this document, it is significant that the term polyolefins is also intended to comprise chemically modified polyolefins, especially polyolefins modified by oxidation (on this subject, see, for example, U.S. Pat. No. 3,786,116).

For the process according to the invention, suitable organic solvents are all of those which have a low water solubility and which can be removed from the aqueous miniemulsion in process step e) in a simple manner, for example by distillation or steam stripping or inert gas stripping. Suitable low water solubility organic solvents are, for example, liquid saturated and unsaturated, aliphatic and aromatic hydrocarbons having from 5 to 9 carbon atoms, for example n-pentane and isomers, cyclopentane, n-hexane and isomers, cyclohexane, n-heptane and isomers, n-octane and isomers, n-nonane and isomers, n-pentene and isomers, cyclopentene, n-hexene and isomers, cyclohexene, n-heptene and isomers, n-octene and isomers, n-nonene and isomers, benzene, toluene, ethylbenzene, cumene, o-, m- or p-xylene, mesitylene and also esters of C₁ to C₄ aliphatic carboxylic acids and C₁ to C₄ aliphatic alcohols, for example the methyl, ethyl, n-propyl, isopropyl or n-butyl esters of formic acid, acetic acid, propionic acid or butyric acid, and/or C₁ or C₂ halohydrocarbons, for example dichloromethane, trichloromethane, ethyl chloride or C₁ or C₂ fluorochlorohydrocarbons. It will be appreciated that it is also possible to use mixtures of the aforementioned solvents.

According to the invention, it is also possible to use gaseous compounds, for example hydrocarbons and/or C₁ fluoro- or fluorochlorohydrocarbons which are gaseous under standard conditions (20° C./1 atm, absolute) but liquid under elevated pressure. Examples of these include propane (liquefaction: 8.8 bar [gauge], 21° C.), propene (liquefaction: 10 bar [gauge], 21° C.), n-butane (liquefaction: 2.1 bar [gauge], 210C) and/or n-butene (liquefaction: 2.7 bar [gauge], 21° C.). With particular advantage, C₄ cuts of a naphtha cracker, in particular the raffinate II cut (consisting of from 30 to 50% by weight of butene-1, from 30 to 50% by weight of butene-2, from 10 to 30% by weight of n-butane and also ≦10% by weight of other compounds), can be used.

The low water solubility organic solvents used in accordance with the invention have, at atmospheric pressure (1 atm, absolute), boiling points in the range of ≦−100 and ≦+100° C., advantageously ≧−60 and ≦+80° C. or ≦+50° C., and especially advantageously ≧−60 and ≦+15° C. It will be appreciated that, in the case of all organic solvents which have a boiling point of ≦30° C., at least process steps a) to d) are carried out at a pressure which ensures that the organic solvent is in liquid form at the temperature under which process steps a) to d) are effected. The pressures may have values of ≧5 bar, ≧10 bar, ≧20 bar or ≧40 bar (gauge). There is in principle no upper limit to the pressures, but pressures of 1000 bar are generally not exceeded for apparatus reasons.

It will be appreciated that it is also possible to use low water solubility organic solvents which have a boiling point ≧100° C./1 atm and form an azeotropic mixture with water having a boiling point of ≦100° C. Examples of such organic solvents are chlorobenzene or toluene.

According to the invention, in process step a), a polymer solution composed of low water solubility polymer and low water solubility organic solvent is prepared. The polymer content in the polymer solution is unlimited. On the basis of practical considerations (for example owing to the viscosity of the polymer solution or the desired content of polymers in the aqueous polymer dispersion), the polymer solution comprises frequently ≧5 and ≦80% by weight, often ≧10 and ≦65% by weight or advantageously ≧15 and ≦50% by weight, of polymer. It is also significant that the polymer is dissolved fully and homogeneously in the organic solvent. The measures for preparing a homogeneous polymer solution are familar to those skilled in the art.

The polymer solution prepared in process step a) is, in process step b), according to the invention, introduced into an aqueous medium which comprises dispersing assistant to form a heterogeneous mixture. The polymer solution can be introduced into an aqueous medium, for example, in a vessel. However, it is also possible to prepare the heterogeneous mixture by introducing the polymer solution and the aqueous medium together into one pipeline.

The dispersing assistants used in the process according to the invention may in principle be emulsifiers and/or protective colloids.

Suitable protective colloids are, for example, polyvinyl alcohols, polyalkylene glycols, alkali metal salts of polyacrylic acids and polymethacrylic acids, gelatin derivatives or copolymers comprising acrylic acid, methacrylic acid, maleic anhydride, 2-acryl-amido-2-methylpropanesulfonic acid and/or 4-styrenesulfonic acid, and alkali metal salts thereof, but also homo- and copolymers comprising N-vinylpyrrolidone, N-vinyl-caprolactam, N-vinylcarbazole, 1-vinylimidazole, 2-vinylimidazole, 2-vinylpyridine, 4-vinylpyridine, acrylamide, methacrylamide, amine-bearing acrylates, methacrylates, acrylamides and/or methacrylamides. A comprehensive description of further suitable protective colloids can be found in Houben-Weyl, Methoden der organischen Chemie [Methods of Organic Chemistry], Volume XIV/, Makromolekulare Stoffe [Macromolecular substances], Georg-Thieme-Verlag, Stuttgart, 1961, p. 411 to 420.

It will be appreciated that mixtures of protective colloids and/or emulsifiers may also be used. Frequently, the dispersants used are exclusively emulsifiers whose relative molecular weights, in contrast to the protective colloids, are typically below 1000. They may be of anionic, cationic or nonionic nature. In the case of the use of mixtures of interface-active substances, it will be appreciated that the individual components have to be compatible with one another, which can be checked in the case of doubt by a few preliminary experiments. In general, anionic emulsifiers are compatible with one another and with nonionic emulsifiers. The same also applies to cationic emulsifiers, while anionic and cationic emulsifiers are usually not compatible with one another. An overview of suitable emulsifiers can be found in Houben-Weyl, Methoden der organischen Chemie, Volume XIV/1, Makromolekulare Stoffe, Georg-Thieme-Verlag, Stuttgart, 1961, p. 192 to 208.

According to the invention, the dispersing assistants used are in particular emulsifiers.

Useful nonionic emulsifiers are, for example, ethoxylated monoalkylphenols, dialkylphenols and trialkylphenols (EO units: 3 to 50, alkyl radical: C₄ to C₁₂) and ethoxylated fatty alcohols (EO units: 3 to 80; alkyl radical: C₈ to C₃₆). Examples of such emulsifiers are the Lutensol® A brands (C₁₂C₁₄ fatty alcohol ethoxylates, EO units: 3 to 8), Lutensol® AO brands (C₁₃C₁₅ oxo alcohol ethoxylates, EO units: 3 to 30), Lutensol® AT brands (C₁₆C₁₈ fatty alcohol ethoxylates, EO units: 11 to 80), Lutensol® ON brands (C₁₀ oxo alcohol ethoxylates, EO units: 3 to 11) and the Lutensol® TO brands (C₁₃ oxo alcohol ethoxylates, EO units: 3 to 20) from BASF AG.

Customary anionic emulsifiers are, for example, alkali metal and ammonium salts of alkyl sulfates (alkyl radical: C₈ to C₁₂), of sulfuric monoesters of ethoxylated alkanols (EO units: 4 to 30, alkyl radical: C₁₂ to C₁₈) and ethoxylated alkylphenols (EO units: 3 to 50, alkyl radical: C₄ to C₁₂), of alkylsulfonic acids (alkyl radical: C₁₂ to C₁₈) and of alkylaryisulfonic acids (alkyl radical: C₉ to C₁₈).

Further anionic emulsifiers which have been found to be useful are compounds of the general formula (I)

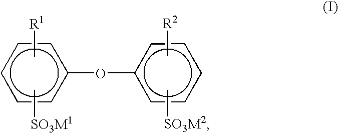

where R¹ and R² are each hydrogen atoms or C₄- to C₂₄-alkyl and are not both hydrogen atoms, and M¹ and M² may be alkali metal ions and/or ammonium ions. In the general formula (i), R¹ and R² are preferably linear or branched alkyl radicals having from 6 to 18 carbon atoms, in particular having 6, 12 or 16 carbon atoms, or hydrogen, but R¹ and R² are not both hydrogen atoms. M¹ and M² are preferably sodium, potassium or ammonium, of which sodium is particularly preferred. Particularly advantageous compounds (I) are those in which M¹ and M² are each sodium, R¹ is a branched alkyl radical having 12 carbon atoms and R² is a hydrogen atom or R¹. Frequently, technical-grade mixtures which have a proportion of from 50 to 90% by weight of the monoalkylated product are used, for example Dowfax® 2A1 (brand of Dow Chemical Company). The compounds (I) are common knowledge, for example from U.S. Pat. No. 4,269,749, and are commercially available.

Suitable cation-active emulsifiers are generally primary, secondary, tertiary or quaternary ammonium salts having a C₆- to C₁₈-alkyl, C₆- to C₁₈-alkylaryl or heterocyclic radical, alkanolammonium salts, pyridinium salts, imidazolinium salts, oxazolinium salts, morpholinium salts, thiazolinium salts and salts of amine oxides, quinolinium salts, isoquinolinium salts, tropylium salts, sulfonium salts and phosphonium salts. Examples include dodecylammonium acetate or the corresponding sulfate, the sulfates or acetates of the various 2-(N,N,N-trimethylammonium)ethylparaffinic esters, N-cetylpyridinium sulfate, N-laurylpyridinium sulfate and N-cetyl-N,N,N-trimethylammonium sulfate, N-dodecyl-N,N,N-trimethylammonium sulfate, N-octyl-N,N,N-trimethylammonium sulfate, N,N-distearyl-N,N-dimethylammonium sulfate and also the gemini surfactant N,N′-(lauryldimethyl)ethylenediamine disulfate, ethoxylated tallow fat alkyl-N-methylammonium sulfate and ethoxylated oleylamine (for example Uniperol® AC from BASF AG, approx. 12 ethylene oxide units). Numerous further examples can be found in H. Stache, Tensid-Taschenbuch [Surfactants Handbook], Carl-Hanser-Verlag, Munich, Vienna, 1981, and in McCutcheon's, Emulsifiers & Detergents, MC Publishing Company, Glen Rock, 1989. It is favorable when the anionic counter-groups have a very low nucleophilicity, for example perchlorate, sulfate, phosphate, nitrate and carboxylates, for example acetate, trifluoroacetate, trichloroacetate, propionate, oxalate, citrate, benzoate, and also conjugate anions of organic sulfonic acids, for example methylsulfonate, trifluoromethylsulfonate and para-toluenesulfonate, and also tetrafluoroborate, tetraphenylborate, tetrakis(pentafluorophenyl)borate, tetrakis[bis(3,5-trifluoromethyl)phenyl]borate, hexafluorophosphate, hexafluoroarsenate or hexafluoroantimonate.

The emulsifiers which are used with preference as dispersing assistants are advantageously used in a total amount of ≧0.005 and ≦20% by weight, preferably ≧0.01 and ≦15% by weight, in particular ≧0.1 and ≦10% by weight, based in each case on the total amount of polymer.

The total amount of the protective colloids used as dispersing assistants in addition to or instead of the emulsifiers is often ≧0.1 and ≦10% by weight and frequently ≧0.2 and ≦7% by weight, based in each case on the total amount of polymer.

However, preference is given to using anionic and/or nonionic emulsifiers and especially preferably anionic emulsifiers as dispersing assistants.

It is significant for the present process that the aqueous medium, in addition to the dispersing assistant, may, if appropriate, comprise further assistants, for example rheology assistants (for example associative thickeners), foam inhibitors, active biocidal ingredients, fine inorganic solids and/or customary stabilizers in amounts customary in each case.

In the preparation of the heterogeneous mixture in process step b), the weight ratio of organic polymer solution to the aqueous medium, depending on the polymer content of the polymer solution and the desired polymer content of the aqueous polymer dispersion, is generally ≧0.1 and ≦5 often ≧0.5 and ≦3 and frequently ≧1 and ≦2.

Advantageously, type and amount of low water solubility polymer and organic solvent are selected such that ≧80% by weight, preferably ≧85% by weight and especially preferably ≧90% by weight, of the resulting polymer solution is present as a separate liquid phase in the crude emulsion and in the miniemulsion.

The heterogeneous mixture obtained in process step b) is converted by means of suitable measures to an oil-in-water emulsion with a mean droplet diameter of ≧2 μm (crude emulsion).

The mean droplet diameter of the aqueous crude emulsion and miniemulsion may be determined, for example, with the aid of an ultrasound extinction probe (for example by means of an Opus unit from Sympatec GmbH) or by means of the method of static light scattering. In the context of this document, the mean droplet diameter is understood to mean the so-called Sauter diameter (d₃₂).

A measure for preparing the crude emulsion which is familiar to those skilled in the art is energy input, for example by mixing using customary stirrers, nozzles, static and/or dynamic mixer units. When the heterogeneous mixture has therefore been prepared in process step b), for example, batchwise in a vessel, especially a mixing vessel, the crude emulsion is typically prepared by stirring the heterogeneous mixture with a stirrer. When, in contrast, the heterogeneous mixture is prepared continuously by introducing the polymer solution and the aqueous medium together into a pipeline, the crude emulsion is prepared advantageously by passing the heterogeneous mixture over static and/or dynamic mixers which are arranged in the pipeline downstream of the introduction sites of the polymer solution and of the aqueous medium (to an intermediate vessel in which the crude emulsion is stored intermediately or directly to the microporous membrane).

It is essential to the process that the oil-in-water emulsion having a mean droplet diameter of ≦1000 nm (miniemulsion) is prepared by passing the crude emulsion thus obtained through at least one microporous membrane. The microporous membrane is selected such that it is capable of forming a miniemulsion taking into account temperature, pressure conditions, loading by crude emulsion, etc. Frequently, preference is given to using microporous membranes having a mean pore diameter of ≦1000 nm for this purpose.

The microporous membranes, especially the microporous membranes having a mean pore diameter of ≦1000 nm, may be conventional ultrafiltration and microfiltration membranes.

Advantageously, the mechanical stability of the microporous membrane is based on a coarse-pore first layer (substructure). It is self-supporting and pressure-stable without any supporting device being required for this purpose. It serves as a support for one or more microporous membranes having a mean pore diameter of ≦1000 nm. In that case, the particular microporous membranes having a mean pore diameter of ≦1000 nm are generally thinner than the substructure.

At least two microporous membranes which have a mean pore diameter of ≦1000 nm and are arranged in series, whose mean pore diameter decreases with increasing distance from the first layer, are preferably applied to the first coarse-pore layer.

It is favorable when the crude emulsion is first passed through the coarse-pore first layer and then through the microporous membrane(s) which have a mean pore diameter of ≦1000 nm and are arranged thereon. Blockage of the microporous membrane(s) is substantially prevented by such an asymmetric structure.

The pore diameter of the coarse-pore first layer is advantageously in the range between 1.5 and 20 μm and its thickness in the range from 0.1 to 10 mm.

A particularly suitable pore diameter of the substructure lies within the same order of magnitude as the droplet diameter of the disperse phase of the crude emulsion, i.e. in the region of ≧2 μm.

The pore diameter of the microporous membrane, which is in a direct correlation to the achieved droplet diameter of the miniemulsion and its droplet size distribution, is preferably in a range of ≧10 and ≦1000 nm, in particular ≦900 nm, ≦700 nm or ≦500 nm and ≧50 nm, ≧100 nm or ≧150 nm. Advantageously, the mean pore diameter is in the range of ≧50 nm and ≦800 nm or ≧70 nm and ≦600 nm. The mean pore diameter of a microporous membrane is determined generally by means of a Coulter Porometer to ASTM E 1294 with isopropanol as the wetting agent. In addition, suitable microporous membranes have a porosity to DIN ISO 30911-3 of from 1% to 70%. The thickness of a microporous membrane is frequently in the range between 1 and 5000 μm, in particular in the range of 1 and 2000 μm.

It is advantageous in accordance with the invention when the mean pore diameter of the first microporous membrane in contact with the crude emulsion is greater than or equal to the mean pore diameter of the second and each further microporous membrane. It is especially advantageous when the mean pore diameter of the first microporous membrane in contact with the crude emulsion is greater than the mean pore diameter of the second and each further microporous membrane. It is favorable when the mean pore diameter of each further microporous membrane decreases further with increasing distance from the first microporous membrane.

Depending on the emulsifying task, the microporous membrane may be used in different geometries and sizes. For example, flat geometries, tubular geometries and multichannel geometries with a plurality of tubular geometries integrated in one unit, and also capillary or wound geometries are possible. More preferably, the microporous membrane has a tubular geometry with internal or external coarse-pore first layer or a flat geometry. Preference is given to pressure-stable self-supporting membrane structures which ensure, without additional supporting elements, sufficient pressure stability even at high transmembrane pressure differences and throughputs on the industrial scale.

The microporous membranes are advantageously sintered metal membranes, ceramic membranes, glass membranes, graphite membranes and/or polymer membranes. According to the invention, microporous membranes are selected such that they are stable toward the components of the crude emulsion under passage conditions (pressure, temperature, etc.).

Particular preference is given to microporous membranes which are composed of hydrophilic materials, for example of metal, ceramic, regenerated cellulose, polyacrylonitrile, hydrophilized polyacrylonitrile, hydrophilized polysulfone or hydrophilized polyethersulfone or hydrophilized polyetheretherketone (on this subject, see, for example, “Ullmann's Encyclopedia of Industrial Chemistry” 6th Edition [electronic]). Especially preferably, at least one microporous metal membrane is used. A measure for the hydrophilicity of a substance is the contact angle of a drop of deionized water on a horizontal, smooth and clean, especially grease-free, surface of this substance. In the context of this document, hydrophilic substances are understood to mean those which have a contact angle of ≦90°, ≦80° or ≦70°.

The microporous membranes can be produced, for example, by sintering the corresponding powder materials, stretching the corresponding polymer films, irradiating the polymer films with high-energy electromagnetic radiation, by etching processes, and also phase inversion of homogeneous polymer solutions or polymer melts.

It is also possible that the microporous membrane is installed symmetrically or integrally asymmetrically. Integrally asymmetric microporous membranes are understood to mean those whose mean pore diameter increases by a factor of from 3 to 1000 from one side to the other side within the microporous membrane layer.

The surface area of the microporous membrane used for the preparation of the miniemulsion is greatly dependent upon factors including the type and the geometry of the microporous membrane used, the composition and the temperature of the crude emulsion used, and also the time within which it is to be passed through the microporous membrane; it can be determined by the skilled person in simple routine experiments.

The temperatures for the inventive passage through the microporous membrane(s) are in principle not restricted. They are frequently in the range of ≧0 and ≦200° C., in particular in the range of ≧20 and ≦150° C. and often in the range of ≧60 and ≦120° C.

The pressure to be applied in order to pass the aqueous crude emulsion through the porous membrane(s) is generated in particular by means of a pump, gas pressure or by hydrostatic head. The transmembrane pressure difference between aqueous crude emulsion and aqueous miniemulsion, which influences the mean droplet diameter and the droplet size distribution, is frequently between 0.1 and 1000 bar, preferably between 0.5 and 100 bar, more preferably between 1 and 50 bar.

Process step d) is effected typically in such a way that the miniemulsion is prepared by passing the crude emulsion once through the at least one microporous membrane, but frequently a plurality of microporous membranes connected in series, or by passing it repeatedly through the at least one microporous membrane, and also by combinations of the aforementioned variants.

The aqueous miniemulsion obtained in process step d) comprises, as the disperse phase, droplets of the polymer solution with a mean diameter of ≦1000 nm. The aqueous polymer dispersion is obtained therefrom by removing the organic solvent from the aqueous miniemulsion. The removal of the organic solvent is effected by customary methods, for example by distillation, by stripping with inert gas, for example nitrogen or argon, and also by stripping with steam.

When the organic solvent is removed in step e) by distillation, this is advantageously effected at a pressure (absolute) which is lower than the pressure prevailing in process steps a) to d). Therefore, an advantageous process is one in which process stages a) to d) are carried out at a higher pressure than process stage e). When process steps a) to d) are carried out, for example, at atmospheric pressure, process step e) is effected advantageously at a pressure which is less than atmospheric pressure. The pressure is selected in such a way that, although the solvent is distilled off, the solvent does not yet boil. Advantageously, the pressure is ≦1 bar, ≦950 mbar, ≦900 mbar, ≦850 mbar, ≦800 mbar (absolute) or even lower values. When, in contrast, process steps a) to d) are effected in the elevated pressure range (>1 atm absolute), because organic solvents are used which are gaseous at atmospheric pressure, it is frequently sufficient when decompression is effected to atmospheric pressure to remove the organic solvent in process step e).

The greater the vapor pressure of the organic solvent at a given temperature and the greater the difference between the vapor pressure of the organic solvent and the vapor pressure of water (at identical temperature), the simpler it is to remove the organic solvent. Especially advantageous organic solvents are those having a low water solubility and a boiling point of ≦30° C., ≦20° C., ≦10° C. or ≦0° C. at atmospheric pressure.

In process step e), the organic solvent is removed from the miniemulsion generally to an extent of ≧80% by weight, frequently to an extent of ≧85% by weight and often to an extent of ≧90% by weight. Residual amounts of solvent remaining in the polymer particles are generally not disruptive in the further use of the aqueous polymer dispersion. When, for example, the aqueous polymer dispersions are used as binders in paint and coating formulations, the remaining organic solvent frequently promotes the filming of the polymer and is subsequently released from it into the atmosphere over a prolonged period.

The process according to the invention makes available aqueous polymer dispersions having a polymer solids content of ≧1 and ≦70% by weight, frequently ≧5 and ≦60% by weight and often ≧10 and ≦50% by weight.

The polymer particles of the aqueous polymer dispersions obtainable by the process according to the invention generally have mean particle diameters which are between 10 and 900 nm, frequently between 50 and 700 nm and often between 100 and 500 nm.

In the context of this document, the mean particle diameter (Sauter diameter d₃₂) and the particle size distribution were determined by means of the method of static light scattering (ISO WD 13320). The Mastersizer S from Malvern Instruments GmbH, Herrenberg, Germany was used.

The particle size distributions obtainable by the process according to the invention are generally narrow. A measure for the uniformity or distribution of the polymer particles is the so-called polydispersity index (PI) which is calculated by the following formula:

PI=(D_{90,3}−D_{10,3})/D_{50,3},

in which D_{90,3}, D_{10,3} and D_{50,3} denote particle diameters for which:
D_{90,3}: 90% by weight of the total mass of all polymer particles has a particle diameter of less than or equal to D_{90,3};
D_{50,3}: 50% by weight of the total mass of all polymer particles has a particle diameter of less than or equal to D_{50,3} and
D_{10,3}: 10% by weight of the total mass of all polymer particles has a particle diameter of less than or equal to D_{10,3}.

The particle size distribution can be determined in a manner known per se, for example by means of the method of static light scattering or of an analytical ultracentrifuge (see, for example, W. Machtle, Makromolekulare Chemie 185 (1984), pages 1025 to 1039), the D_{90,3}, D_{50,3} and D_{10,3} values are derived therefrom and the polydispersity indices are determined. According to the invention, the polydispersity indices are in the range from 0.1 to 4, preferably in the range from 0.3 to 3 and especially preferably in the range from 0.5 to 1.5.

The process according to the invention makes available aqueous polymer dispersions from widely chemically differing polymers in a simple manner. The process is technically simple to carry out and the mean particle sizes of the aqueous polymer dispersions can be adjusted in a controlled manner by the selection of the microporous membranes and the passage conditions of the crude emulsion through the membrane (pressure, temperature, flow per unit time, etc.). In addition, the polymer particles of the resulting aqueous polymer dispersions generally have narrow particle size distributions. Furthermore, the process according to the invention overall has a low energy input, as a result of which aqueous polymer dispersions with low coagulate contents can be prepared. The microporous membranes used as main components in the process according to the invention also do not have any moving parts which are therefore prone to be in need of repair, which results in low maintenance costs.

### EXAMPLE

500 g of granular polybutene-1 DP 8510 (from BASELL GmbH) was initially charged at room temperature (20 to 25° C.) in a 3 l pressure vessel (dissolution vessel) under a nitrogen atmosphere, and 1000 g of liquid raffinate II (composition: 39.3% by weight of butene-1, 23.7% by weight of trans-butene-2, 13.0% by weight of cis-butene-2, 18.6% by weight of n-butane, 3.3% by weight of isobutane, 1.8% by weight of isobutene and 0.3% by weight of other compounds) were subsequently introduced via a feed line. The feed line was then closed and the vessel contents heated to 110° C. with stirring, in the course of which the polymer dissolved fully. In the vessel, there was an elevated pressure of approx. 23 bar. By injecting nitrogen, an internal vessel pressure of 28 bar was established at the temperature mentioned.

In a 7 l vessel (emulsification vessel), 2800 g of deionized water, 30 g of sodium lauryl sulfate and 20 g of Viscalex® HV30 (associative thickener; 30% by weight solution of a polyacrylate in water, commercial product from Ciba Spezialitaten-Chemie) were mixed homogeneously with stirring under a nitrogen atmosphere at room temperature, and the resulting surfactant solution was likewise heated to 110° C. The internal vessel pressure was then set to 23 bar by injecting nitrogen.

Subsequently, the polymer solution was passed from the dissolution vessel via an immersed tube, with pressure equalization between the two vessels, into the emulsification vessel, and the resulting mixture was stirred at 1400 revolutions per minute (rpm) for 15 minutes to form a crude emulsion.

Subsequently, the crude emulsion, with constant stirring at 1400 rpm at 110° C., was passed back into the emulsification vessel via the lid of the emulsification vessel through an outlet orifice disposed in the bottom of the emulsification vessel via a line in which were disposed a GM-K/9 gear pump from Gather Industrie GmbH, Germany, and also, connected thereto in parallel arrangement, cylindrical sintered metal membranes with closed ends (surface area in each case 14 cm²; from Swagelok, Solon, Ohio, USA) with a mean pore diameter of 2 μm or 0,5 μm. The procedure was such that the emulsion was passed first through the 2 μm membrane with a pump output of 85% of the maximum pump output for 75 minutes and then through the 0.5 μm membrane for 55 minutes to form a miniemulsion. Afterward, the raffinate II which served as the solvent was removed from the aqueous polymer dispersion by cautious decompression of the emulsification vessel to atmospheric pressure (1 atm=1.01 bar absolute), and the resulting aqueous polymer dispersion was subsequently cooled to room temperature.

The resulting aqueous polymer dispersion was stable over many months and had a solids content of approx. 15% by weight. The mean polymer particle diameter was determined to be 290 nm.

The solids content was determined by drying a defined amount of the aqueous polymer dispersion (approx. 5 g) to constant weight at 180° C. in a drying cabinet. Two separate measurements were carried out in each case. The value reported in the example constitutes the mean value of the two measurement results.

### COMPARATIVE EXAMPLE

The comparative example was carried out analagously to example 1 with the difference that the crude emulsion formed was not pumped through the membranes via the external circuit line.

After the cooling, however, an unstable polymer dispersion was obtained, in which a polymer film floating on the aqueous phase formed within 2 hours.

1. A process for preparing an aqueous polymer dispersion, which comprises
a) first preparing an organic polymer solution formed from a low water solubility polymer and a low water solubility organic solvent, then
b) introducing the resulting organic polymer solution into an aqueous medium which comprises dispersion assistant, then
c) converting the resulting heterogeneous mixture by means of suitable measures to an oil-in-water emulsion with a mean droplet diameter of ≧2 μm (crude emulsion), then
d) passing the resulting crude emulsion through a microporous membrane to form an oil-in-water emulsion with a mean droplet diameter ≦1000 nm (miniemulsion), and then
e) removing the organic solvent from the miniemulsion.

2. The process according to claim 1, wherein the organic polymer solution comprises ≧5 and ≦80% by weight of polymer.

3. The process according to claim 1, wherein the low water solubility polymer used is a polyolefin, polyester, polyamide, polyurethane, polycarbonate or a polymer which has been obtained by free-radical polymerization of a monomer mixture comprising
from 50 to 99.9% by weight of esters of acrylic and/or methacrylic acid with alkanols having from 1 to 20 carbon atoms, or
from 50 to 99.9% by weight of styrene and/or butadiene, or
from 50 to 99.9% by weight of vinyl chloride and/or vinylidene chloride, or
from 40 to 99.9% by weight of vinyl acetate, vinyl propionate, vinyl esters of versatic acid, vinyl esters of long-chain fatty acids and/or ethylene.

4. The process according to claim 1, wherein process stages a) to d) are carried out at a higher pressure than process stage e).

5. The process according to claim 1, wherein organic solvents having a boiling point of ≧−60 and ≦+15° C./1 atm (absolute) are used.

6. The process according to claim 1, wherein the organic solvent used is the raffinate II cut of a naphtha cracker.

7. The process according to claim 1, wherein the crude emulsion is obtained by stirring the heterogeneous mixture obtained from the organic polymer solution and the aqueous medium by means of static and/or dynamic mixers, or by passing it over them.

8. The process according to claim 1, wherein the microporous membrane has a mean pore diameter of ≦1000 nm.

9. The process according to claim 1, wherein the microporous membrane used is a sintered metal membrane, ceramic membrane, glass membrane, graphite membrane and/or polymer membrane.

10. The process according to claim 1, wherein the transmembrane pressure differential is between 0.1 and 1000 bar.

11. The process according to claim 1, wherein the microporous membrane has a hydrophilic surface.

12. The process according claim 1, wherein the dispersing assistant used is an emulsifier.

13. The process according to claim 1, wherein the dispersing assistant used is an anionic emulsifier.

14. The process according to claim 1, wherein the emulsifiers used as dispersing assistants are used in an amount of ≧0.01 and ≦15% by weight based on the total amount of polymer.

15. The process according to claim 1, wherein the weight ratio of organic polymer solution to the aqueous medium is ≧0.1 and ≦5.

16. The process according to claim 1, wherein type and amounts of low water solubility polymer and organic solvent are selected such that ≧80% by weight of the resulting polymer solution is present as a separate liquid phase in the crude emulsion and in the miniemulsion.
